(19) United States
(12) Patent Application Publication
(10) Pub. No.: US 2012/0327286 A1
(43) Pub. Date: Dec. 27, 2012

(54) LIQUID LENS DEVICE AND CAMERA

(76) Inventor: Yoshio Imura, Kawasaki-shi (JP)

(21) Appl. No.: 12/449,113

(22) PCT Filed: Jan. 23, 2008
(86) PCT No.: PCT/JP2008/050883

§ 371 Date: Feb. 5, 2010

(30) Foreign Application Priority Data
Jan. 24, 2007 (JP) 2007-013895

(51) Int. Cl. G02B 3/14; H04N 5/225

(52) U.S. Cl. 348/335; 359/666; 348/E05.024

(57) ABSTRACT

A liquid lens device includes: a circular tube with a liquid pressurization port formed therein; a first elastic film and a second elastic film each closing off one of two ends of the circular tube, so as to form a lens chamber inside the circular tube; and a pressurization unit that pressurizes the lens chamber via the liquid pressurization port, wherein: the first elastic film and the second elastic film are deformed in states different from each other by pressure inside the lens chamber pressurized by the pressurization unit.

### TECHNICAL FIELD

The present invention relates to a liquid lens device and a camera.

### BACKGROUND ART

The contours of the optical surfaces of a liquid lens known in the related art are altered via a liquid filling the inside of the lens (see, for instance, patent reference 1). Patent reference:

Japanese Laid Open Patent Publication No. 2002-147260

### DISCLOSURE OF THE INVENTION

### Problems to be Solved by the Invention

There is still an issue to be addressed in the liquid lens in the related art in that since the curvature on the photographic field side and the curvature of the imaging side are the same, the desired optical features may not always be achieved with ease.

### Means for Solving the Problems

A liquid lens device according to the present invention comprises: a circular tube with a liquid pressurization port formed therein; a first elastic film and a second elastic film each closing off one of two ends of the circular tube, so as to form a lens chamber inside the circular tube; and a pressurization unit that pressurizes the lens chamber via the liquid pressurization port, wherein: the first elastic film and the second elastic film are deformed in states different from each other by pressure inside the lens chamber pressurized by the pressurization unit.

It is preferred that in the liquid lens device described above, the first elastic film and the second elastic film take the pressure in the lens chamber over pressure-receiving areas different from each other so that the first elastic film in the second elastic film are deformed in states different from each other by the pressure inside the lens chamber. It is possible that in this liquid lens device, an inner diameter at one end of the circular tube is different from the inner diameter at another end of the circular tube.

It is possible that in the liquid lens device according to the present invention, the first elastic film and the second elastic film assuming predetermined levels of tension different from each other are disposed at the two ends of the circular tube so that first elastic film and the second elastic film are deformed in states by the pressure inside the lens chamber.

In the liquid lens device according to the present invention, the first elastic film and the second elastic film may take the pressure in the lens chamber over pressure-receiving areas equal to each other but assuming at least one of different thicknesses and different Young's moduli so that the first elastic film and the second elastic film are deformed in states different from each other by the pressure inside the lens chamber.

It is preferred that in the liquid lens device described above, the first elastic film and the second elastic film are each connected at an end of the circular tube and the end surfaces of the circular tube are formed so as to achieve curvatures respectively equal to the curvature of the first elastic film and the curvature of the second elastic film at the liquid lens device in an operating state.

It is preferred that the pressurization unit of the liquid lens device according to the present invention further includes a depressurizing function for depressurizing the lens chamber.

A camera according to the present invention is equipped with a liquid lens device described above.

It is preferred that the camera described above further is equipped with: a drive unit that drives the liquid lens device between a photographing position and a retracted position; and a control unit that first engages the drive unit to drive the liquid lens device to the photographing position as power to the camera is turned on and then engages the pressurization unit to start pressurizing the liquid lens device. Furthermore, it is referred that as the power to the camera is turned off, the control unit depressurizes the liquid lens device via the pressurization unit and then engages the drive unit to drive the liquid lens device to the retracted position.

### Effect of the Invention

According to the present invention, which allows different curvatures to be assumed on the photographic field side and the imaging side, the desired optical features can be more easily achieved.

### BRIEF DESCRIPTION OF THE DRAWINGS

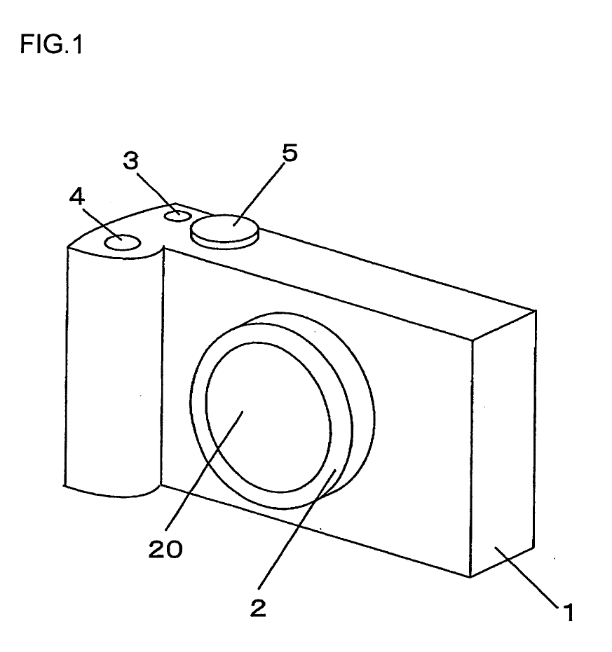

(FIG. 1) An external view of the camera achieved in an embodiment of the present invention

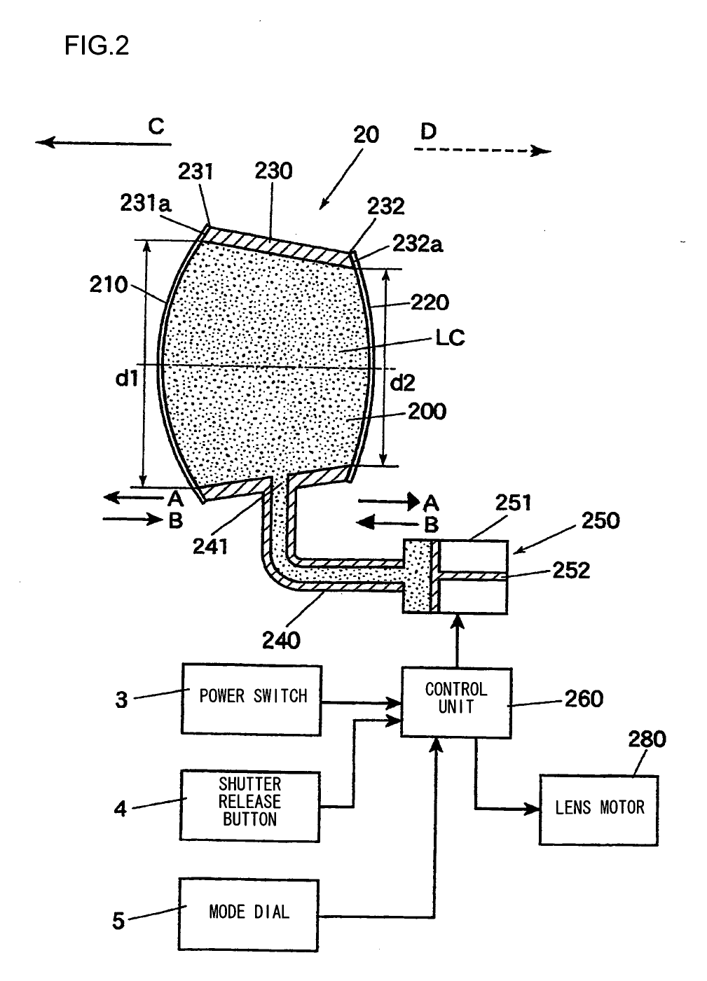

(FIG. 2) The structure of the liquid lens device achieved in a first embodiment

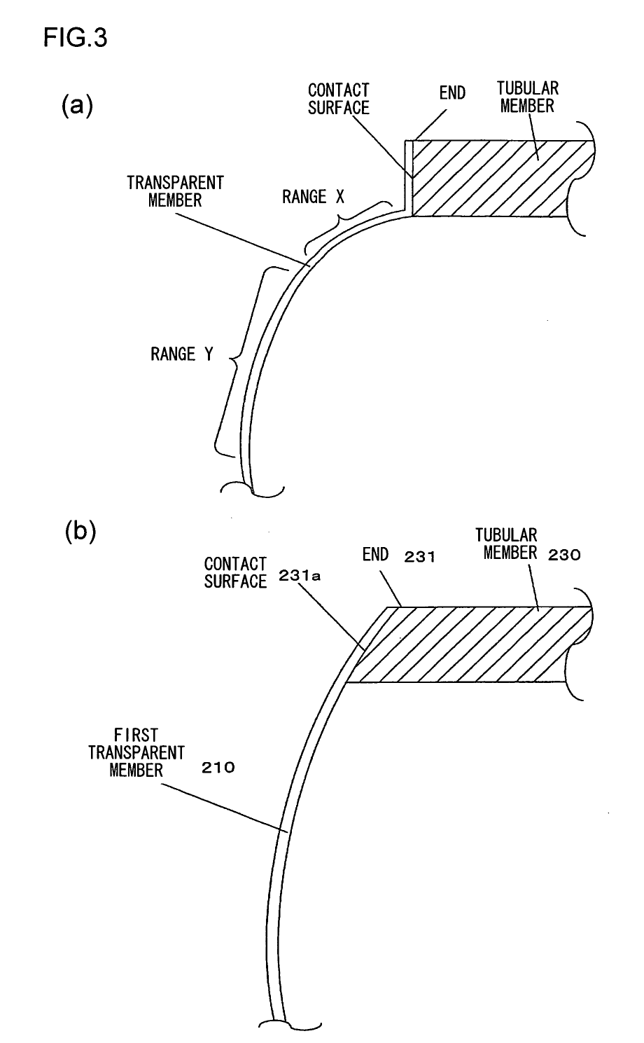

(FIG. 3) Enlarged views each showing an area near the contact surface along which a transparent member and a tubular member are connected

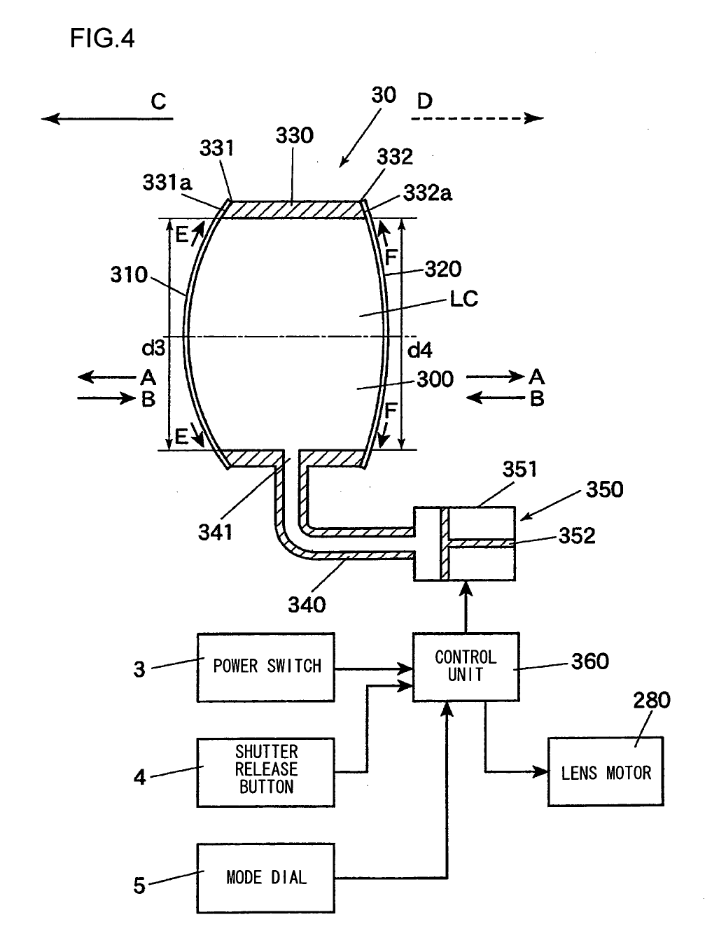

(FIG. 4) The structure of the liquid lens device achieved in a second embodiment

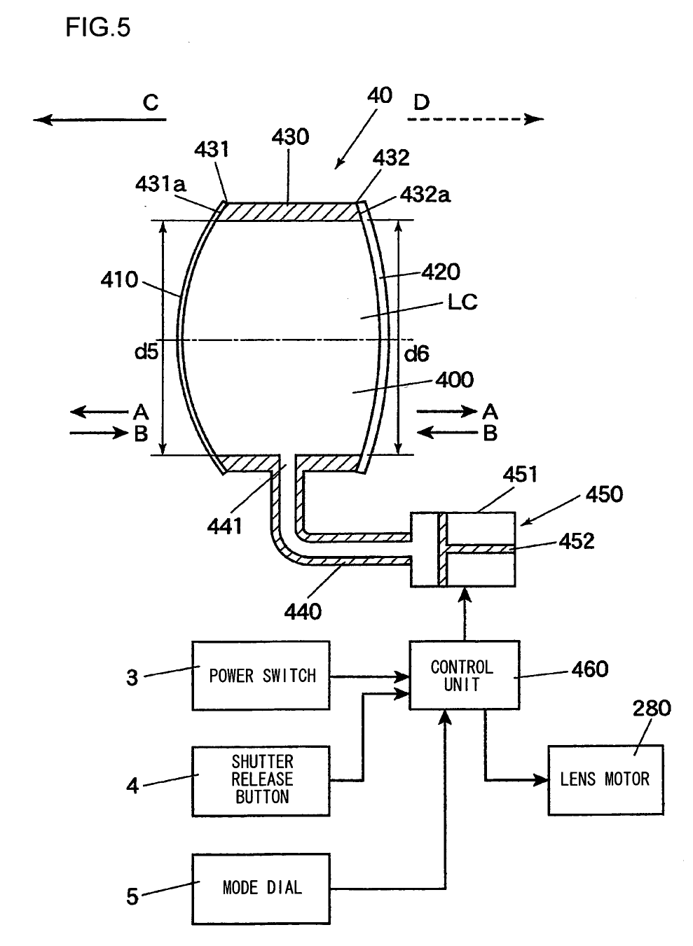

(FIG. 5) The structure of the liquid lens device achieved in a third embodiment

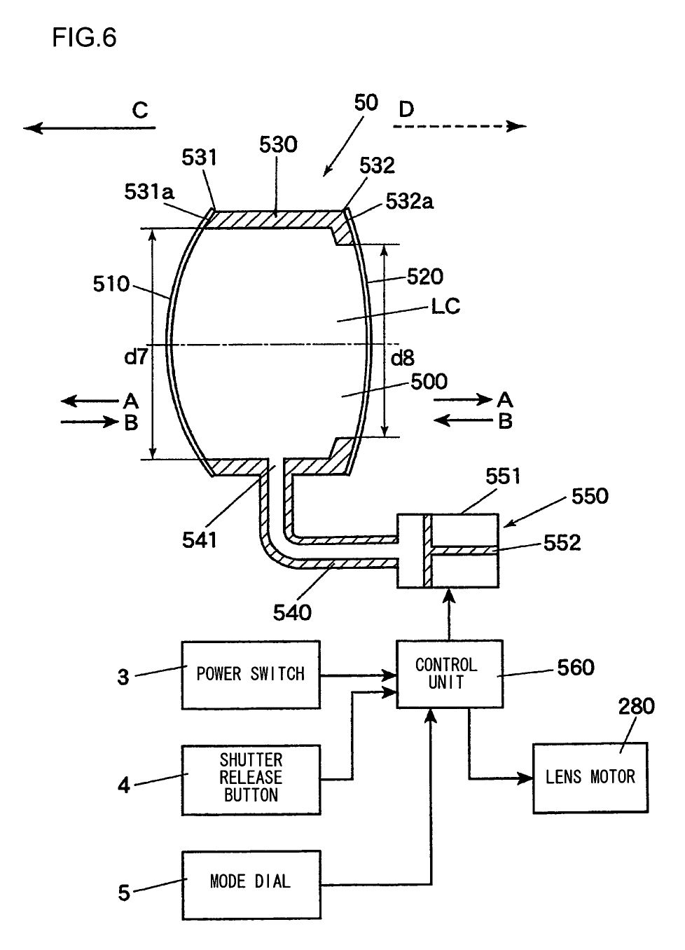

(FIG. 6) A variation of the liquid lens device structure achieved in a fourth embodiment

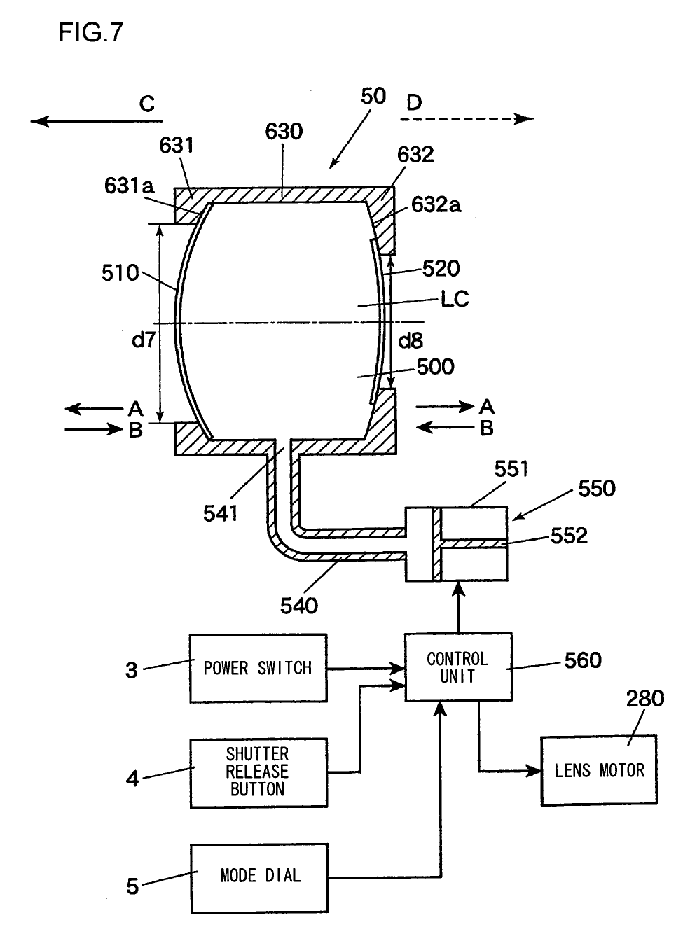

(FIG. 7) A variation in the tubular member structure achieved in conjunction with the liquid lens device in the fourth embodiment

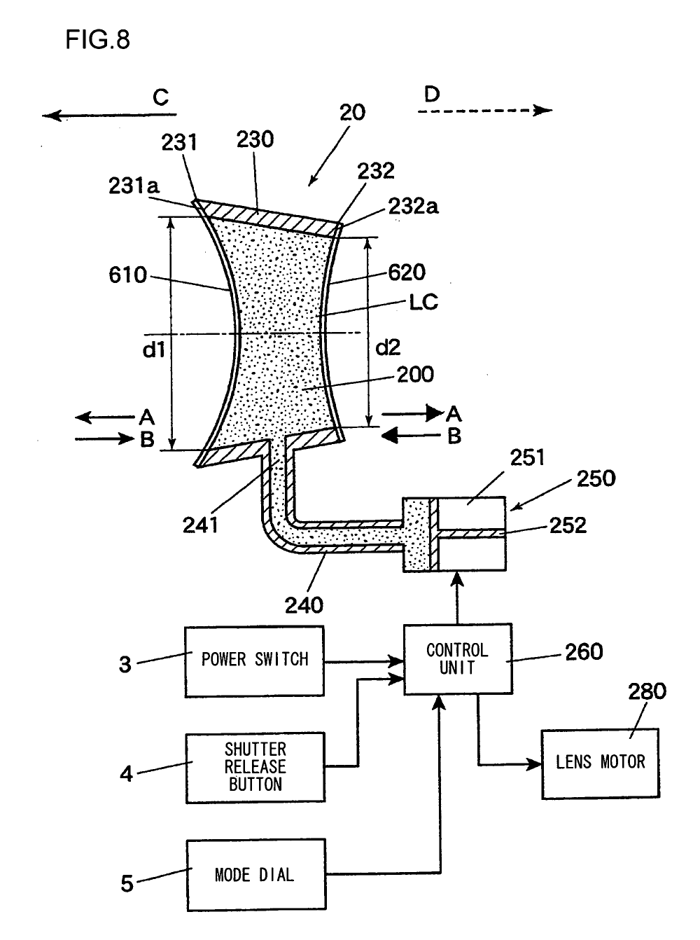

(FIG. 8) The liquid lens device in the first embodiment structured as a bi-concave optical lens

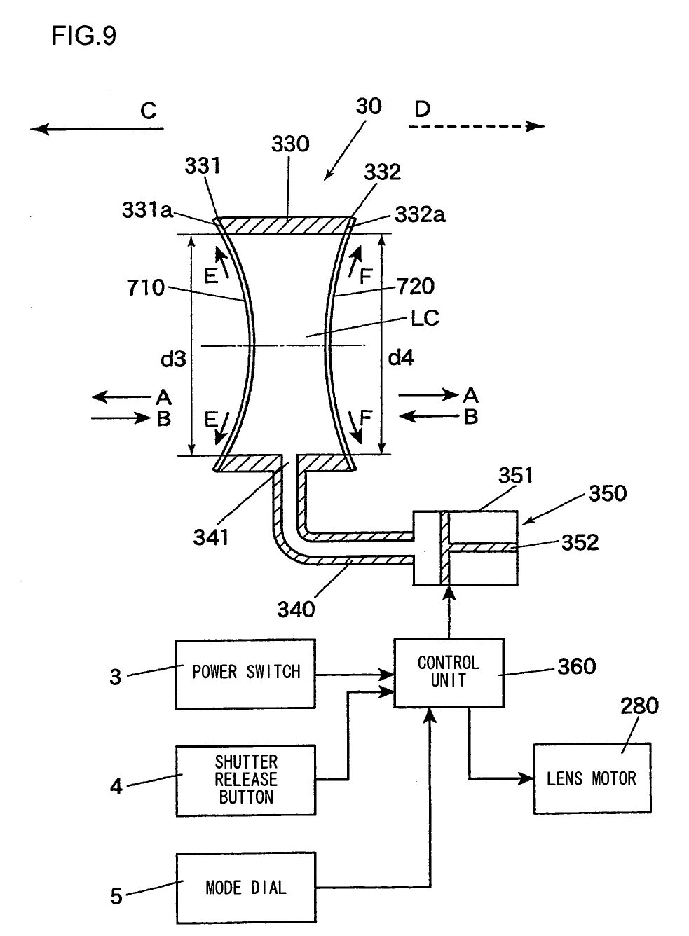

(FIG. 9) The liquid lens device in the second embodiment structured as a bi-concave optical lens

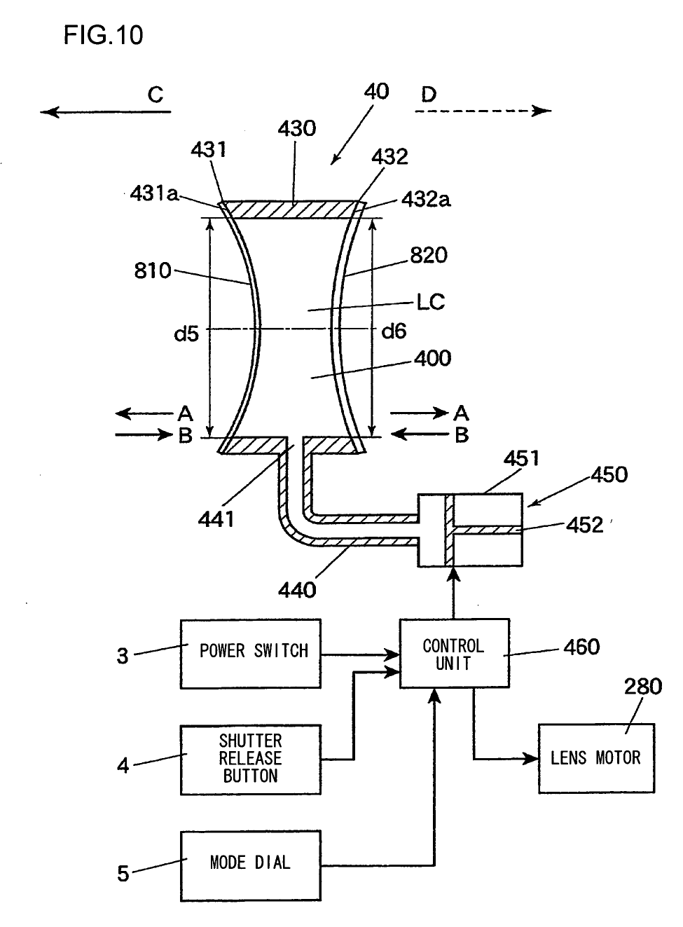

(FIG. 10) The liquid lens device in the third embodiment structured as a bi-concave optical lens

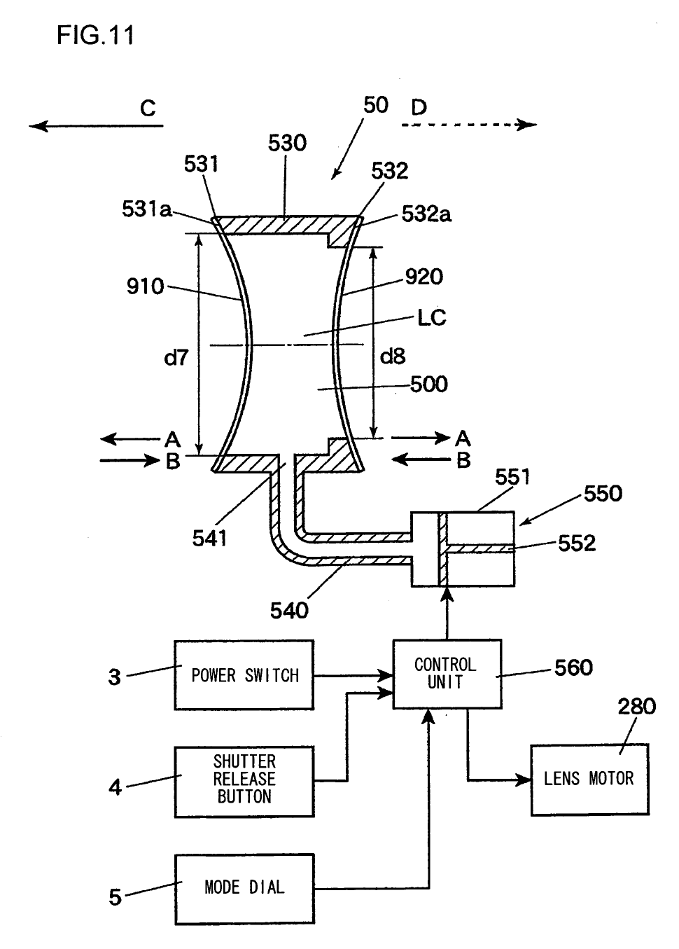

(FIG. 11) The liquid lens device in the fourth embodiment structured as a bi-concave optical lens

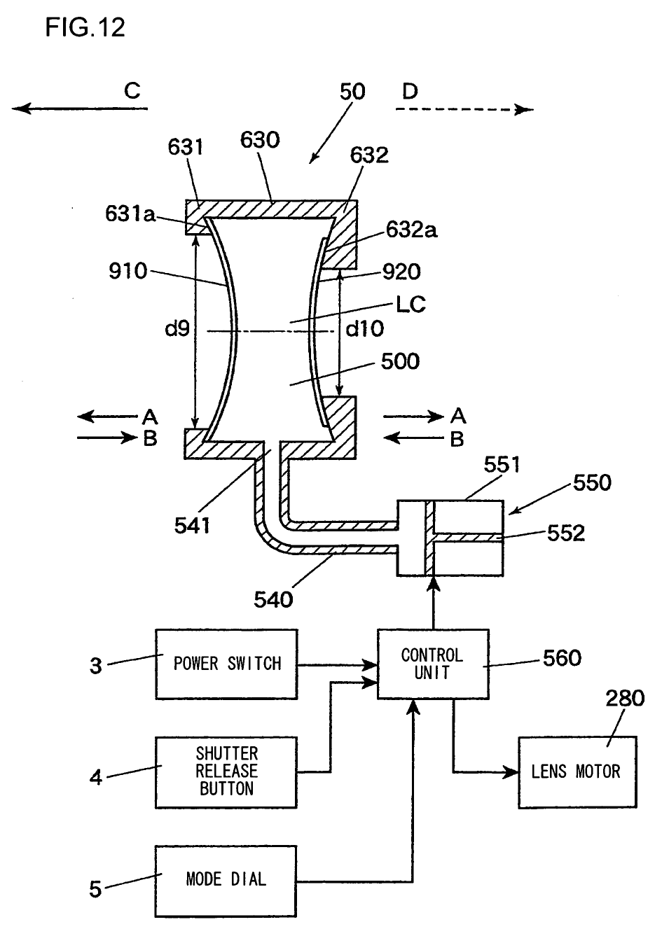

(FIG. 12) A variation in the tubular member structure achieved in conjunction with the liquid lens device in FIG. 11

### BEST MODE FOR CARRYING OUT THE INVENTION

First Embodiment

In reference to a drawing, a digital camera that includes the liquid lens device achieved in the first embodiment of the present invention is described.

FIG. 1 is a perspective showing the front of the digital camera. A lens barrel 2 that includes a liquid lens device 20, a power switch 3, a shutter release button 4 and a mode dial 5 via which a photographing mode is set, are disposed at a camera body 1. The lens barrel 2 is a retractable lens barrel that is driven out from the camera body 1 along the optical axis in response to an ON operation of the power switch 3 and is stored back into the camera body 1 in response to an OFF operation of the power switch 3.

In reference to FIG. 2, the liquid lens device 20 is described. FIG. 2 is a sectional view taken across a plane that includes the optical axis of the liquid lens device 20. In FIG. 2, the solid arrow C points toward the subject side and the dotted line arrow D points toward the imaging surface side. It is to be noted that the one-point chain line in FIG. 2 indicates the optical axis.

The liquid lens device 20 includes a first transparent member 210, a second transparent member 220, a circular tubular member 230, a pipeline 240, a liquid supply quantity adjustment unit 250 and a control unit 260. The first transparent member 210 and the second transparent member 220 are each constituted with a transparent thin film material that can be elastically deformed. The first transparent member 210 and the second transparent member 220 each form an optical surface of the liquid lens device 20. It is to be noted that the first transparent member 210 and the second transparent member 220 in the embodiment are constituted of identical material of the same thickness.

The tubular member 230 is a tapered circular tube, assuming different diameters d1 and d2 its two ends 231 and 232. It is to be noted that the embodiment is described by assuming that the diameter d1 is greater than the diameter d2. The first transparent member 210 is connected to the end 231 of the tubular member 230. A contact surface 231 a at the end 231 over which the end 231 connects with the first transparent member 210 is a ring-shaped convex surface projecting out toward the subject along the optical axis with a predetermined curvature. The contact surface 231a is formed so that its curvature is substantially equal to the curvature of the first transparent member 210 set in the operating state as pressure is applied at the liquid lens device 20, as explained later. In addition, the second transparent member 220 is connected to the end 232 of the tubular member 230. As is the contact surface 231a at the end 231, a contact surface 232a at the end 232 over which the end 232 connects with the second transparent member, is a ring-shaped convex surface with a predetermined curvature, projecting out toward the imaging surface along the optical axis. The surface 232a is similar to the contact surface 231a in that it is formed so as to achieve a curvature substantially equal to the curvature of the second transparent member 220 set in the operating state as pressure is applied at the liquid lens device 20. The contact surfaces 231a and 232a in the embodiment are formed so as to assume curvatures different from each other. The tubular member 230 is connected to the first transparent member 210 and the second transparent member 220 via, for instance, sealing members, and a lens chamber LC is formed in the internal space defined by the tubular member and the transparent members.

The lens chamber LC formed by the first transparent member 210, the second transparent member 220 and the tubular member 230 is filled with a predetermined quantity of liquid 200 with a desired refractive index, such as water, oil or alcohol. In correspondence to the pressure of the liquid 200 filling the space, the first transparent member 210 and the second transparent member 220 are deformed. As the lens chamber LC is pressurized, the first transparent member 210 is deformed so as to project out toward the subject side along the optical axis within the range defined by the diameter d1 at the end 231 of the tubular member 230. The second transparent member 220, on the other hand, is deformed so as to project out toward the imaging surface along the optical axis within the range defined by the diameter d2 at the end 232 of the tubular member 230. Namely, the first transparent member 210 is deformed so as to achieve a curvature substantially equal to the curvature at the contact surface 231a. Likewise, the second transparent member 220 is deformed along the optical axis so as to achieve a curvature substantially equal to the curvature of the contact surface 232a.

In the operating state in which the lens chamber LC is pressurized, the pressure of the liquid 200 is uniformly applied to the unit areas at the first transparent member 210 and the second transparent member 220. Since the diameter d1 is greater than the diameter d2, the pressure applied to the first transparent member 210 over its deformable range is greater than the pressure applied to the second transparent member 220 over its deformable range. Accordingly, the extent (deformation quantity) by which the first transparent member 210 is deformed to project out toward the subject side along the optical axis is greater than the extent (deformation quantity) by which the second transparent member 220 is deformed to project out toward the imaging surface side along the optical axis. Namely, the first transparent member 210 is deformed by an extent equivalent to a greater curvature compared to the second transparent member 220. As a result, a biconvex optical lens achieving different curvatures on the subject side and the imaging surface side is formed.

An intake port 241 is formed on the circumferential surface of the tubular member 230 with one end of a flexible pipeline 240 connected to the intake port 241. Another end of the pipeline 240 is connected to the liquid supply quantity adjustment unit 250.

The liquid supply quantity adjustment unit 250, which includes a cylinder 251 and a piston 252, functions as a pressurizing device that pressurizes the lens chamber LC of the liquid lens device 20. The piston 252 is disposed inside the cylinder 251 so as to move reciprocally to the left and right in FIG. 2. As the piston 252 is driven to the left in FIG. 2, the lens chamber LC is pressurized to an extent corresponding to the distance over which the piston 252 has been driven. In addition, as the piston 252 is driven to the right in FIG. 2, the lens chamber LC is depressurized to an extent corresponding to the distance over which the piston 252 has been driven.

The control unit 260 controls the pressure inside the lens chamber LC by controlling the extent to which the piston 252 is driven (drive quantity) via the liquid supply quantity adjustment unit 250.

As a power ON signal is input from the power switch 3, the control unit 260 drives a lens motor 280 so as to drive the lens barrel 2 at the retracted position to the photographing position. Subsequently, the control unit 260 controls drive of the liquid supply quantity adjustment unit 250. Namely, the liquid supply quantity adjustment unit 250 pressurizes the lens chamber LC by extending the piston 252 by a predetermined extent. As the lens chamber LC is pressurized, the first transparent member 210 and the second transparent member 220 are deformed along the optical axis (along the direction indicated by the arrow A in FIG. 2), each forming a convex surface with a predetermined curvature. The liquid lens device 20 forms a biconvex optical lens as explained earlier and enters the operating state under these conditions.

As a power OFF signal is input from the power switch 3, the control unit 260 controls drive of the liquid supply quantity adjustment unit 250. Namely, the liquid supply quantity adjustment unit 250 causes the piston 252, currently in the extended state, to contract so as to depressurize the lens chamber LC. As the lens chamber LC is depressurized, the first transparent member 210 and the second transparent member 220 are deformed along the optical axis (along the direction indicated by the arrow B in FIG. 2), each assuming the contour of a substantially flat surface. Subsequently, the control unit 260 drives the lens motor 280 so as to drive the lens barrel 2 at the photographing position back to the retracted position.

The following advantages are achieved through the liquid lens device 20 in the first embodiment described above.

(1) The tubular member 230 of the liquid lens device 20 assumes different diameters d1 and d2 respectively at the end 231, to which the first transparent member 210 is fixed, and at the end 232, to which the second transparent member 220 is fixed. Due to the difference between the diameter d1 and the diameter d2, the first transparent member 210 and the second transparent member 220 are deformed so as to assume contours with curvatures different from each other as the lens chamber LC is pressurized. As a result, the liquid lens device 20 forms a biconvex optical lens achieving different curvatures on the subject side and the imaging surface side. Thus, any undesirable image field curvature, skew aberration (distortion) or the like can be corrected at the optical system constituted with the lens device 20. Moreover, a liquid lens affording a higher level of freedom in the design related to the principal point position can be provided.

(2) The curvature of the ring-shaped contact surface 231a at the end 231 of the tubular member is set substantially equal to the curvature of the first transparent member 210 set in the operating state as the lens chamber LC is pressurized. In addition, the curvature of the ring-shaped contact surface 232a at the end 232 is set substantially equal to the curvature of the second transparent member 220 set in the operating state as the lens chamber LC is pressurized. FIG. 3(a) presents an enlarged view of an area near a contact surface, the curvature of which does not match the curvature of the transparent member, whereas FIG. 3(b) presents an enlargement of an area near a contact surface 231a with a curvature substantially equal to the curvature of the first transparent member 210. When the curvature of the contact surface and the curvature of the transparent member do not match, as shown in FIG. 3(a), the transparent member assumes different curvatures over a range X and over a range Y. In other words, part of the transparent member over the range X cannot be utilized as a lens optical surface. In contrast, as long as the curvature of the contact surface 231 a and the curvature of the first transparent member 210 are substantially equal to each other, as shown in FIG. 3(b), the first transparent member 210 in its entirety is allowed to assume a substantially uniform curvature. By ensuring that the first transparent member 210 and the second transparent member 220 each sustain a uniform curvature through the outer periphery thereof, the lens can be provided as a more compact unit.

Second Embodiment

In reference to FIG. 4, a liquid lens device 30 achieved in the second embodiment is described by focusing on the difference from the liquid lens device 20 in the first embodiment.

The liquid lens device 30 includes a first transparent member 310, a second transparent member 320, a tubular member 330, a pipeline 340, a liquid supply quantity adjustment unit 350 and a control unit 360. The tubular member 330 is a circular tube with one end 331 thereof and the other end 332 thereof assuming diameters d3 and d4 equal to each other. The first transparent member 310 is connected to the end 331 of the tubular member 330. A predetermined level of tension is assumed at the first transparent member 310 toward the outer circumference of the circle formed with the end 331, centered on the optical axis, i.e., along the direction indicated by the arrow E in FIG. 4.

The second transparent member 320 is connected to the end 332 of the tubular member 330. As at the first transparent member 310, a predetermined level of tension is assumed at the second transparent member 320 toward the outer circumference of the circle formed with the end 332, centered on the optical axis, i.e., along the direction indicated by the arrow F in FIG. 4. It is assumed that a higher level of tension is assumed at the second transparent member compared to the level of tension assumed at the first transparent member 310 in the liquid lens device 30 in the embodiment. In addition, the first transparent member 310 and the second transparent member 320 are constituted of identical material of the same thickness in this embodiment as well.

As in the first embodiment, ring-shaped contact surfaces 331a and 332a over which the tubular member connects with the first transparent member 310 and the second transparent member 320 are formed so as to achieve specific curvatures along the optical axis. The contact surface 331a is formed so as to achieve a curvature substantially equal to the curvature of the first transparent member 310 when the liquid lens device 30 is in the operating state. Likewise, the contact surface 332a is formed so as to achieve a curvature substantially equal to the curvature of the second transparent member 320 when the liquid lens device 30 is in the operating state.

As the lens chamber LC of the liquid lens device 30 structured as described above is pressurized with a liquid 300 supplied by the liquid supply quantity adjustment unit 350 through the pipeline 340 and an intake port 341, the first transparent member 310 is deformed so as to project out toward the subject side along the optical axis and the second transparent member 320 is deformed so as to project out toward the imaging surface side along the optical axis. Since the first transparent member 310 and the second transparent member 320 take the pressure over equal pressure-receiving areas, and thus, the levels of pressure applied to the two members are equal. Since the tension assumed at the first transparent member 310 is smaller than the tension assumed at the second transparent member 320, the first transparent member 310 is caused to deform by a greater extent (deformation quantity) along the optical axis than the second transparent member 320. The first transparent member 310 thus achieves a greater curvature than the second transparent member 320. As a result, the liquid lens device 30 forms a biconvex optical lens achieving different curvatures on the subject side and the imaging surface side.

In addition to the advantage (2) of the first embodiment described above, the following advantage is achieved through the liquid lens device 30 in the second embodiment.

The level of tension assumed at the first transparent member 310 as it is connected to the tubular member 330 is different from the level of tension assumed at the second transparent member 320 as it is connected to the tubular member 330. As a result, while the first transparent member 310 and the second transparent member 320 are subjected to equal levels of pressure as the lens chamber LC is pressurized and the liquid lens device 30 enters the operating state, the varying levels of tension assumed at the first transparent member and the second transparent member cause the first transparent member 310 and the second transparent member 320 to become deformed along the optical axis with curvatures different from each other. Namely, a biconvex optical lens assuming different curvatures on the subject side and the imaging surface side can be formed with the liquid lens device 30. Thus, any undesirable image field curvature, skew aberration (distortion) or the like can be corrected at the optical system constituted with the lens device 20. Moreover, a liquid lens affording a higher level of freedom in the design related to the principal point position can be provided.

Third Embodiment

In reference to FIG. 5, a liquid lens device 40 achieved in the third embodiment is described by focusing on the difference from the liquid lens device 30 in the second embodiment. The liquid lens device 40 in the third embodiment includes a first transparent member 410 and a second transparent member 420 constituted of identical material but with different thicknesses, each connected to one of the two end surfaces of a cylindrical member 430. Thus, as the lens chamber LC is pressurized, the first transparent member 410 and the second transparent member 420 are deformed to achieve curvatures different from each other.

Fourth Embodiment

In reference to FIG. 6, a liquid lens device 50 achieved in the fourth embodiment is described by focusing on the difference from the liquid lens device 20 in the first embodiment. While a uniform outer diameter is assumed at the two ends of a cylindrical member 530 in the liquid lens device 50 achieved in the fourth embodiment, the opening on the subject side is formed so as to achieve a greater inner diameter d7 than the inner diameter d8 at the opening on the imaging surface side. As a result, a first transparent member 510 is made to take the pressure over a greater pressure-receiving area Al compared to a pressure-receiving area A2 over which a second transparent member 520 takes the pressure, and ultimately, as the lens chamber LC is pressurized, the first transparent member 510 and the second transparent member 520 are deformed to achieve curvatures different from each other.

It is to be noted that instead of the cylindrical member 530, a cylindrical member 630 such as that shown in FIG. 7 may be used so as to set a greater pressure-receiving area A1 for the first transparent member 510 relative to the pressure-receiving area A2 for the second transparent member 520.

While a biconvex lens is formed with the liquid lens device in each of the embodiments described above, the liquid lens device according to the present invention may form a biconcave lens, as shown in FIGS. 8-11.

FIG. 8 shows a liquid lens device structurally similar to the liquid lens device 20 in the first embodiment, which forms a biconcave optical lens. The pressure-receiving area A1 at a first transparent member 610 is greater than the pressure-receiving area A2 at a second transparent member 620. As the control unit 260 causes the piston 252 to contract and thus depressurize the lens chamber LC, the first transparent member 610 and the second transparent member 620 become deformed to assume concave contours having curvatures different from each other. The curvature at the first transparent member 610 with the pressure-receiving area A1 is greater than the curvature at the second transparent member 620 with the pressure-receiving area A2.

FIG. 9 shows a liquid lens device structurally similar to the liquid lens device 30 in the second embodiment, which forms a biconcave optical lens. In this case, as the control unit 360 causes the piston 352 to contract and thus depressurize the lens chamber LC, the first transparent member 710 and the second transparent member 720 become deformed to assume concave contours having curvatures different from each other. The curvature at the first transparent member 710 assuming the lower level of tension is greater than the curvature at the second transparent member 720 assuming the higher level of tension.

FIG. 10 shows a liquid lens device structurally similar to the liquid lens device 40 in the third embodiment, which forms a biconcave optical lens. In this case, as the control unit 460 causes the piston 452 to contract and thus depressurize the lens chamber LC, the first transparent member 810 and the second transparent member 820 become deformed to assume concave contours having curvatures different from each other. The curvature at the first transparent member 810 having the smaller thickness is greater than the curvature at the second transparent member 820 having the greater thickness.

FIG. 11 shows a liquid lens device structurally similar to the liquid lens device 50 in the fourth embodiment, which forms a biconcave optical lens. The pressure-receiving area A1 at a first transparent member 910 is greater than the pressure-receiving area A2 at a second transparent member 920. As the control unit 560 causes the piston 552 to contract and thus depressurize the lens chamber LC, the first transparent member 910 and the second transparent member 920 become deformed to assume concave contours having curvatures different from each other. The curvature at the first transparent member 910 with the pressure-receiving area A1 is greater than the curvature at the second transparent member 920 with the pressure-receiving area A2.

It is to be noted that a cylindrical member 630 such as that shown in FIG. 12 may be used so as to set a greater pressure-receiving area A1 for the first transparent member 910 relative to the pressure-receiving area A2 for the second transparent member 920.

The liquid supply quantity adjustment unit 250 does not need to be constituted with the cylinder 251 and the piston 252 and may adopt any structure as long as it allows the liquid supply quantity adjustment unit to pressurize and depressurize the lens chamber LC to predetermined pressure levels. For instance, it may be constituted with a pump and a tank where the liquid is stored.

Instead of connecting the first transparent member 410 and the second transparent member 420 constituted of identical materials with different thicknesses to the two end surfaces of the cylindrical member 430, the liquid lens device 40 may include a first transparent member 410a and a second transparent member 420a constituted of different materials. In such a case, the first transparent member 410a and the second transparent member 420a constituted of the different materials are bound to assume different Young's moduli. As a result, as a given pressure is applied to the first transparent member 410a and the second transparent member 420a, they will be deformed through elastic deformation to varying extents (deformation quantities). In other words, as the lens chamber LC is pressurized, the first transparent member 410a and the second transparent member 420a will be deformed to achieve curvatures different from each other.

While the invention has been particularly shown and described with respect to preferred embodiments thereof by referring to the attached drawings, the present invention is not limited to these examples and it will be understood by those skilled in the art that various changes in form and detail may be made therein without departing from the spirit, scope and teaching of the invention.

The disclosure of the following priority application is herein incorporated by reference:

Japanese Patent Application No. 2007-13895 filed Jan. 24, 2007

1. A liquid lens device, comprising:
a circular tube with a liquid pressurization port formed therein;
a first elastic film and a second elastic film each closing off one of two ends of the circular tube, so as to form a lens chamber inside the circular tube; and
a pressurization unit that pressurizes the lens chamber via the liquid pressurization port, wherein:
the first elastic film and the second elastic film are deformed in states different from each other by pressure inside the lens chamber pressurized by the pressurization unit.

2. A liquid lens device according to claim 1, wherein:
the first elastic film and the second elastic film take the pressure in the lens chamber over pressure-receiving areas different from each other so that the first elastic film in the second elastic film are deformed in states different from each other by the pressure inside the lens chamber.

3. A liquid lens device according to claim 2, wherein:
an inner diameter at one end of the circular tube is different from the inner diameter at another end of the circular tube.

4. A liquid lens device according to claim 1, wherein:
the first elastic film and the second elastic film assuming predetermined levels of tension different from each other are disposed at the two ends of the circular tube so that first elastic film and the second elastic film are deformed in states by the pressure inside the lens chamber.

5. A liquid lens device according to claim 1, wherein:
the first elastic film and the second elastic film take the pressure in the lens chamber over pressure-receiving areas equal to each other but assuming at least one of different thicknesses and different Young's moduli so that the first elastic film and the second elastic film are deformed in states different from each other by the pressure inside the lens chamber.

6. A liquid lens device according to claim 1, wherein:
the first elastic film and the second elastic film are each connected at an end of the circular tube and the end surfaces of the circular tube are formed so as to achieve curvatures respectively equal to the curvature of the first elastic film and the curvature of the second elastic film at the liquid lens device in an operating state.

7. A liquid lens device according to claim 1, wherein:
the pressurization unit further includes a depressurizing function for depressurizing the lens chamber.

8. A camera equipped with a liquid lens device according to claim 1.

9. A camera according to claim 8, further equipped with:
a drive unit that drives the liquid lens device between a photographing position and a retracted position; and
a control unit that first engages the drive unit to drive the liquid lens device to the photographing position as power to the camera is turned on and then engages the pressurization unit to start pressurizing the liquid lens device.

10. A camera according to claim 9, wherein:
as the power to the camera is turned off, the control unit depressurizes the liquid lens device via the pressurization unit and then engages the drive unit to drive the liquid lens device to the retracted position.
